(19) United States
(12) Patent Application Publication
(10) Pub. No.: US 2011/0111118 A1
(43) Pub. Date: May 12, 2011

(54) PROCESS FOR THE SCREENED APPLICATION OF FLUIDS TO SUBSTRATES

(75) Inventors: MARTIN SCHMITT-LEWEN, HEIDELBERG (DE); JOACHIM SONNENSCHEIN, MUHLTAL (DE); EVGENY KURMAKAEV, OBERTSHAUSEN (DE); MARTIN HAAS, DARMSTADT (DE)

(73) Assignee: HEIDELBERGER DRUCKMASCHINEN AG, HEIDELBERG (DE)

(21) Appl. No.: 12/943,123

(22) Filed: Nov. 10, 2010

(30) Foreign Application Priority Data
Nov. 10, 2009 (DE) DE 102009052421.5

(51) Int. Cl. B41M 3/00

(52) U.S. Cl. 427/145

(57) ABSTRACT

A process for screened application of fluids to substrates includes i) providing a substrate being unscreened at least in a portion or a coating of the substrate unscreened at least in the portion, having a screened first image of a first fluid applied to the substrate in the portion, or ii) a substrate being screened at least in the portion or a coating of the substrate screened at least in the portion, having a first image of a first fluid with a different screen applied to the substrate in the portion (preferably with an offset printing form in i) and ii)). An unscreened second image of a second fluid (preferably transparent varnish) is applied to the substrate, covering the first image, in the portion (preferably with flexographic printing form). Formation of the second fluid on the substrate in the portion is substantially determined with the screen of the first image.

### CROSS-REFERENCE TO RELATED APPLICATION

This application claims the priority, under 35 U.S.C. §119, of German Patent Application DE 10 2009 052 421.5, filed Nov. 10, 2009; the prior application is herewith incorporated by reference in its entirety.

### BACKGROUND OF THE INVENTION

### Field of the Invention

The present invention relates to a process for the screened application of fluids to substrates.

In the field of producing printed products, it is already known to optically further finish products that have preferably been produced by using offset printing, for example with so-called spot varnishes. It is furthermore also known to functionally enhance the products, for example by applying lenticular films to create so-called animated or flip images.

An offset printing process is disclosed in German Patent DE 103 60 050 B3, corresponding to U.S. Patent Application Publication No. US 2006/0230965, in which a printing substrate is first printed with oil-based offset printing ink and is then coated with a transparent, oil-based matt varnish containing particulate matting agents and finally completely overlaid with a transparent water-based gloss varnish, for example a dispersion varnish. The matt varnish is applied only to part of the surface of the printing substrate, whereas the gloss varnish is applied to the whole surface. Both the matt and the gloss varnish are applied without any screening and instead as homogeneous isotropic coatings. Only the offset printing inks appear to be applied with a printing screen, as is normal in offset printing. The process described therein is known by the name “drip-off” and according to the disclosure thereof results in high-contrast matt/gloss effects.

German Published, Non-Prosecuted Patent Application DE 10 2006 003 311 A1 describes a process for creating image effects that can change depending on the angle from which they are viewed, wherein a varnish screen (dot screen or line screen) is first applied to a base layer of varnish that covers all or only part of the surface and a UV varnish is then applied to the exposed locations of the base layer of varnish. The UV varnish forms a layer with a lenticular function and, lastly, is dried. Underneath the three layers described is printing ink in a layer of ink applied by offset printing devices, which forms a multi-colored printed subject. In order to guarantee the lenticular function of the layer of UV varnish, the screen of the second varnish or of the correspondingly formed UV varnish must be matched to a screen of the printed subject. In other words, the lenticular screen of the image and of the lenses must be the same.

The market for high-quality printed products moreover is always looking for new optically attractive and/or functionally enhanced printed products, or printed optically attractive and/or functional features on conventional printed products.

### SUMMARY OF THE INVENTION

It is accordingly an object of the invention to provide a process for the screened application of fluids to substrates, which is an improvement over and overcomes the hereinafore-mentioned disadvantages of the heretofore-known processes of this general type and which makes it possible to produce optically attractive and/or functionally enhanced printed products simply and with known technical measures, and in particular to obtain effect features on printed products quickly, inexpensively and in large volumes or to simulate known effects of more expensive features by corresponding effects of less expensive features.

With the foregoing and other objects in view there is provided, in accordance with the invention, a process for the screened application of fluids to substrates. The process comprises:
in a case i) of a substrate that is unscreened at least in a portion, or of a coating of the substrate that is unscreened at least in the portion, a screened first image of a first fluid is applied to the substrate in the portion, or
in a case ii) of a substrate that is screened at least in the portion, or of a coating of the substrate that is screened at least in the portion, a first image of a first fluid that has a different screen (from that of the substrate or its coating) is applied to the substrate or its coating in the portion,
an unscreened second image, covering the first image, of a second fluid is applied to the substrate or its coating in the portion, and
the formation of the second fluid on the substrate or its coating in the portion is substantially determined by the screen of the first image in the portion.

The term “second image” also encompasses the homogeneous isotropic application of the second fluid with no information content, i.e. for example sprayed-on second fluid in the form of a layer covering the entire surface of the portion. With the formation of the second fluid in accordance with the screen (the pattern) of the first fluid, the final structure can nevertheless carry information, for example a corresponding (preferably negative) pattern. The application can, however, be made over part of the surface of the portion, for example in so-called spots or also in a structured fashion, for example in the form of a pattern.

According to the invention, a first fluid is applied that is screened, in contrast to the drip-off effect from the prior art. Moreover, the screen of this first fluid is not, as in the lenticular effect from the prior art, matched to a screen lying underneath it (of the substrate or of a coating of the substrate) but surprisingly is chosen so that it differs therefrom. As long as the substrate or its coating is unscreened, there is of course no need to concern oneself with the difference.

According to the invention, the second fluid is formed in accordance with the screen of the first fluid, i.e. the second fluid collects at the locations where the first fluid is or is not present, depending on how the respective wetting properties have been adjusted. It preferably does not wet the first fluid or only does so poorly and thus collects at the more easily wetted locations at which none of the first fluid is present, and thus as it were in the screen gaps on the substrate or its coating.

According to the invention, a screen is thus advantageously created from a second fluid using a first fluid. Since this screen from a second fluid is not matched to an underlying screen of the substrate or its coating (with the exception of the first fluid necessary for the formation), no lenticular effect can occur. However, this is precisely what is desired according to the invention since the screen from the second fluid should give rise at least to an optical effect of its own accord (and thus also on an unstructured, homogeneous, isotropic single-color background) and without any lens interaction (optical refraction) with the background. For example, this effect can be a directionally dependent gloss or a pattern that is discernible optically (light/dark) or to the touch (raised/lowered). Alternatively, this effect can take the form of a reflection, coloration, transparency or scattering that is modified locally by the second fluid according to its screen.

In accordance with another advantageous and therefore preferred mode of the invention, the first image for the second fluid represents a latent, preferably transparent wetting image. It is thereby advantageous that the first fluid influences the optically discernible effects of the screen generated from the second fluid only by its screen and not by its color. A color effect can thus be generated by a coloration of the second fluid alone and in an undisturbed fashion. A wetting-modifying fluid known from the production of the drip-off effect, for example the matt varnish described in the prior art, can thereby be used as the first fluid.

In accordance with a further advantageous and therefore preferred mode of the invention, the second fluid is a transparent varnish. It can moreover be advantageous also to choose a colorless fluid for the second fluid and so to obtain substantially undisturbed gloss effects. An additional color effect or metallic effect can in this case be obtained by an underlying printed image or cold foil transfer material forming the background. In this way surfaces such as, for example, brushed steel or abrasive or polished patterns can be simulated inexpensively by using printing technology. Alternatively, natural structures (fur, leather) or cracks can be simulated.

In accordance with an added advantageous and therefore preferred mode of the invention, the first image is applied as a halftone image. It is thereby advantageous that highly detailed effects or effects having sequences can be obtained by the screen of the first fluid. The first image can thus be built up as a graphic image and not have only coarse screen structures, as is sufficient for producing lenticular images. The above-mentioned simulation of highly detailed natural structures can be achieved simply in this way.

In accordance with an additional advantageous and therefore preferred mode of the invention, the first image has an anisotropy, preferably by virtue of the use of a line screen, and as a result the second image has a directionally dependent gloss. It is particularly advantageous in this connection that, due to the anisotropic prestructuring through the use of the first fluid, a correspondingly anisotropic structuring of the second fluid that is applied in an unstructured fashion or only in spots can be achieved simply.

In accordance with yet another advantageous and therefore preferred mode of the invention, the second fluid contains effect pigments (microparticles) that generate interference phenomena. All of the effects that have already been mentioned up until now can be intensified or further enhanced by additionally using such effects of the pigments. In the case of the directionally dependent gloss mentioned, the superimposed effect of additional effect pigments can result in a further enhancement of the product and in stunningly attractive, complex effects despite a simple manner of production using printing technology.

In accordance with yet a further advantageous and therefore preferred mode of the invention, a tinted third fluid, preferably offset printing ink, or metallic-gloss foil transfer material, preferably cold foil transfer material containing metal particles, is applied to the substrate before the first fluid. As mentioned above, it can be advantageous to combine the color effect of an underlying image or the metallic gloss of underlying cold foil transfer material with the screen effects according to the invention, and thereby to achieve intensified optical effects, in particular metallic-look effects.

In accordance with yet an added advantageous and therefore preferred mode of the invention, the first fluid is applied with a first printing form, an offset printing form or a letterpress printing form preferably being used as the first printing form. More preferably, a flexographic printing form can be used as a letterpress printing form.

In accordance with yet an additional advantageous and therefore preferred mode of the invention, the second fluid is applied with a second printing form or with a spraying device.

In accordance with a concomitant advantageous and therefore preferred mode of the invention, a flexographic printing form, an offset printing form applying water varnish, a gravure printing form or a silkscreen printing form is preferably used as the second printing form. Of particular advantage are such application processes that can achieve a layer thickness which is sufficient for a formation.

Other features which are considered as characteristic for the invention are set forth in the appended claims.

Although the invention is illustrated and described herein as embodied in a process for the screened application of fluids to substrates, it is nevertheless not intended to be limited to the details shown, since various modifications and structural changes may be made therein without departing from the spirit of the invention and within the scope and range of equivalents of the claims.

The construction and method of operation of the invention, however, as well as constructively and/or functionally advantageous further developments of the invention, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a flow chart showing a preferred embodiment of a process according to the invention; and

FIG. 2 is a flow chart showing a further preferred embodiment of a process according to the invention.

### DETAILED DESCRIPTION OF THE INVENTION

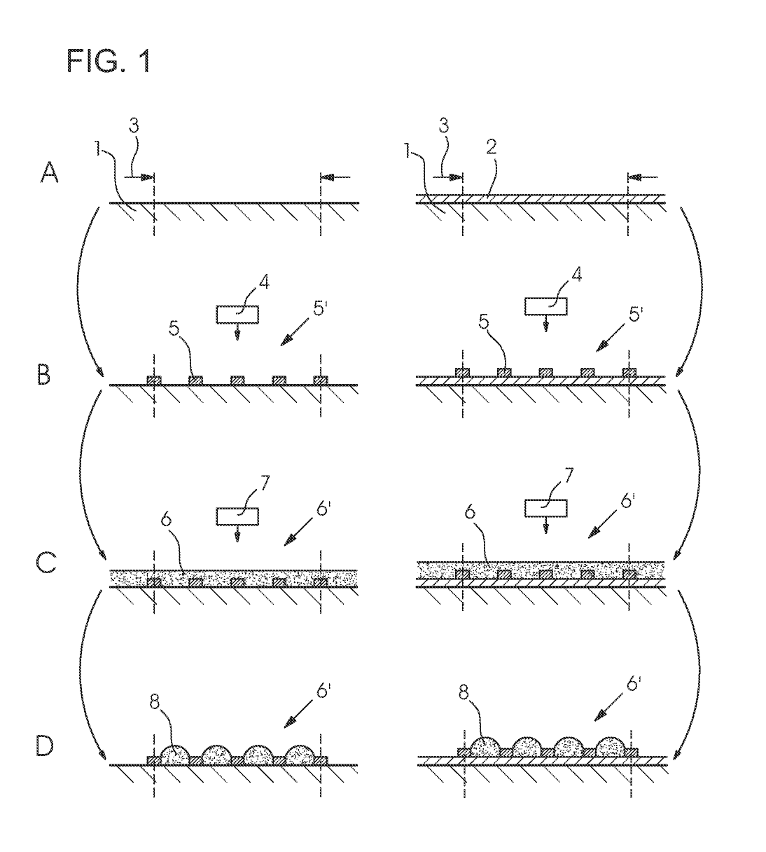

Referring now in detail to the figures of the drawings, in which mutually corresponding elements are provided with the same reference numerals, and first, particularly, to FIG. 1 thereof, there is seen a flow chart of a preferred embodiment of a process according to the invention for the screened application of fluids to substrates (according to case i described above). The left-hand side of the figure illustrates a process for the provision of an unscreened substrate 1 and the right-hand side of the figure illustrates a process for the provision of a substrate 1 with an unscreened coating 2. Both sides illustrate a portion 3 in which a treatment, i.e. an application of fluid, substantially takes place.

In a process step A, the substrate 1 or the substrate 1 with the coating 2 is provided for subsequent process steps. The substrate 1 can be a printing substrate such as paper, cardboard or foil. The coating 2 can be a homogeneous layer of ink or varnish, which may, for example, be single-color or colorless, or a homogeneously applied cold foil transfer material, for example with a metallic gloss. The process step A, and subsequent process steps B to D as well, can be performed in a printing machine with a feeder, offset printing units, varnishing units, a cold foiling module, a dryer and a delivery (disposed one after the other in accordance with the process).

In the process step B, a first fluid 5 is applied to the substrate 1 or its coating 2 using a first application device 4. The application device 4 can be a printing form, preferably an offset printing form. The first fluid 5 can be a transparent varnish. The first fluid 5 is applied as a screened or rastered first image 5′, preferably as a halftone image. The screen can be a dot or line screen. The first fluid 5 can have a property which causes a second fluid 6 applied in the subsequent process step C to wet the first fluid 5 less well than the substrate 1 or its coating 2. To this end, the first fluid 5 preferably has a lower surface energy than the substrate 1 or its coating 2. The first image 5′ can therefore represent a latent, preferably transparent wetting image for the second fluid 6. A wetting-modifying fluid used in the known drip-off effect such as, for example, oil-based matt varnish, can therefore be used as the first fluid 5.

In the process step C, the second fluid 6 is applied to the substrate 1 or its coating 2, as well as to the first fluid 5, using a second application device 7. The application device 7 can be a printing form, preferably a flexographic printing form, or a spraying device. The second fluid 6 can be a transparent varnish too but also a tinted varnish (containing pigments or microparticles) as well. The second fluid 6 is applied as an unscreened second image 6′ that covers the first image 5′ at least in the portion 3 and at least part of its surface located there. The second fluid 6 temporarily forms a layer which, however, is subjected to screening in the subsequent process step D by formation. The second fluid 6 is preferably applied wet-in-wet, i.e. before the first fluid 5 has dried substantially. Known water-based gloss varnish can also be used as the second fluid.

In the process step D, a formation 8 of the second fluid 6 is effected on the substrate 1 or its coating 2 in the portion 3. This formation 8 is determined substantially by the screen of the first image 5′ in the portion 3. In the example shown, droplets of the second fluid 6 run off the first fluid 5 and collect at those locations on the substrate 1 or its coating 2 that are not coated by the first fluid 5. The layer thickness of the second fluid 6 is increased at these locations in such a way that effects result which are discernible optically and/or to the touch (the thickness can be increased further by the use of embossing varnish). It is, however, not necessary to obtain similar layer thicknesses, as in the production of lens screens, since according to the invention no significant lens effect (optical refraction) needs to be achieved. For example, the first image 5′ has an anisotropy, preferably by virtue of the use of a line screen, and consequently the second image 6′ has a directionally dependent gloss. The second fluid 6 can additionally contain effect pigments, generating interference phenomena, which intensify the optical effect, in particular when a directionally dependent gloss is present. Alternatively, it is also possible to adjust the wetting properties of the materials involved in such a way that the second fluid 6 collects at the locations of the first fluid 5.

In other words, the second fluid 6 applied without a screen is subjected to a formation, on the substrate 1 or its coating 2, which is controlled or determined by the first fluid 5 that is applied with a screen. In contrast to the known matt/gloss effect, however, the running-off in droplets does not take place in an uncontrolled fashion but instead the second fluid 6 runs off according to the predetermined and locally resolved structure of the first fluid 5 in droplets and collects according to a negative structure. This structure that is formed is preferably so fine that optical effects such as, for example, a directionally dependent gloss can occur and at the same time is so coarse that a sufficient amount of the second fluid 6 runs off locally in droplets and collects locally. A local accumulation of the second fluid 6, and as a result improved optical or even haptic/tactile effects, can also thereby occur.

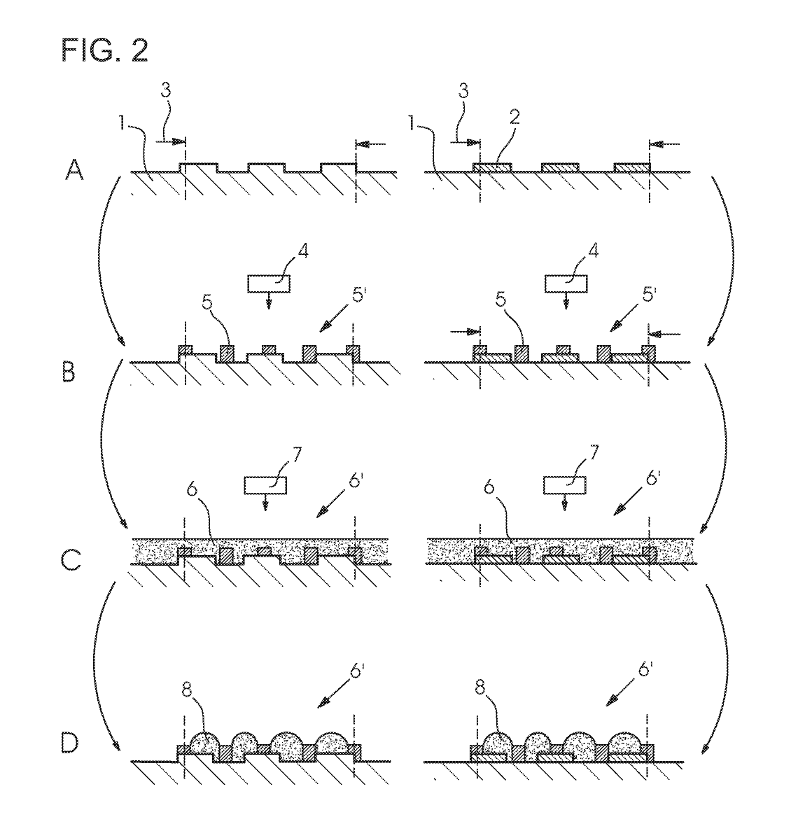

FIG. 2 shows a flow chart of a further preferred embodiment of a process according to the invention for the screened application of fluids to substrates (according to case ii described above). The left-hand side of the figure illustrates a process for the provision of a screened substrate 1, and the right-hand side of the figure illustrates a process for the provision of a substrate 1 with a screened coating 2.

In a process step A, the provision according to FIG. 1 takes place. The screened substrate 1 can be an embossed substrate. The coating 2 can be a screened layer of ink or varnish or cold foil transfer material applied with a screen and preferably with a metallic gloss/containing metal particles. The screen can be a dot or line screen.

In a process step B, the first application of fluid according to FIG. 1 takes place. It can be clearly seen in FIG. 2 that the screen of the first fluid 5 is different from the underlying screen of the substrate 1 or its coating 2. The difference can reside in the two screens having different screen shapes and/or screen sizes and/or screen pitches and/or screen angles. The screen of the first fluid 5 can have dots, ellipses, stars or lines as screen shapes.

Therefore, whereas care needs to be taken to match the screens in the production of lenticular images, according to the invention such matching is avoided. Since the final structure from the second fluid 6 does not need to serve as a lens screen for an underlying image (for example, a flip or animated image), nor should pronounced moiré effects occur as a result of poor matching. Instead, the final structure should produce an effect from the second fluid 6 itself, i.e. without any significant interaction with underlying structures.

In a process step C, the second application of fluid takes place and in a process step D the formation according to FIG. 1 takes place.

A printed product produced in this way according to the invention can include: a substrate 1, offset printing ink 2 and/or cold foil transfer material 2, screened transparent wetting-modifying fluid 5 and a transparent varnish 6 with substantially the same screen. A feature correspondingly produced according to the invention on an otherwise conventional printed product can include on the substrate 1: offset printing ink 2 and/or cold foil transfer material 2, screened transparent wetting-modifying fluid 5 and a transparent varnish 6 with substantially the same screen. Such a feature can also be used as a so-called security feature, for example for checking authenticity, due to its optically and haptically/tactilely attractive effect. When metallic-gloss cold foil transfer material 2 is used as the background and effect pigments added by the second fluid 6, such as for example so-called Iriodins, are used, the feature can seem like a hologram, although it can be produced “inline” using printing technology much more simply and inexpensively and with known technical measures, i.e. an expensive application (for example, adhesive bonding) can be dispensed with.

1. A process for the screened application of fluids to substrates, the process comprising the following steps:
i) providing a substrate being unscreened at least in a portion or a coating on the substrate being unscreened at least in the portion and having a screened first image of a first fluid applied to the substrate in the portion, or
ii) providing a substrate being screened at least in the portion or a coating on the substrate being screened at least in the portion and having a first image of a first fluid with a different screen applied to the substrate in the portion;
applying an unscreened second image of a second fluid to the substrate in the portion, covering the first image; and
substantially determining a formation of the second fluid on the substrate in the portion with the screen of the first image in the portion.

2. The process according to claim 1, wherein the first image represents a latent wetting image for the second fluid.

3. The process according to claim 1, wherein the first image represents a latent transparent wetting image for the second fluid.

4. The process according to claim 1, wherein the second fluid is a transparent varnish.

5. The process according to claim 1, wherein the first image is applied as a halftone image.

6. The process according to claim 1, wherein the first image has an anisotropy, resulting in the second image having a directionally dependent gloss.

7. The process according to claim 1, wherein the first image has an anisotropy due to use of a line screen, resulting in the second image having a directionally dependent gloss.

8. The process according to claim 1, wherein the second fluid contains effect pigments generating interference phenomena.

9. The process according to claim 1, which further comprises applying a tinted third fluid to the substrate before the first fluid.

10. The process according to claim 9, which further comprises selecting the tinted third fluid from the group consisting of offset printing ink, metallic-gloss foil transfer material and cold foil transfer material containing metal particles.

11. The process according to claim 1, which further comprises applying the first fluid with a first printing form.

12. The process according to claim 11, wherein the first printing form is an offset printing form or a letterpress printing form.

13. The process according to claim 11, which further comprises applying the second fluid with a second printing form or with a spraying device.

14. The process according to claim 12, which further comprises applying the second fluid with a second printing form or with a spraying device.

15. The process according to claim 13, which further comprises selecting the second printing form from the group consisting of a flexographic printing form, an offset printing form applying water varnish, a gravure printing form and a silkscreen printing form.

16. The process according to claim 14, which further comprises selecting the second printing form from the group consisting of a flexographic printing form, an offset printing form applying water varnish, a gravure printing form and a silkscreen printing form.
